(19) United States
(12) Patent Application Publication
(10) Pub. No.: US 2004/0040277 A1
(43) Pub. Date: Mar. 4, 2004

(54) Socket device with fastening unit used in rake or shovel

(75) Inventor: Shui-Hsiang Yen, Sanchung City (TW)

Correspondence Address: LOWE HAUPTMAN GOPSTEIN, GILMAN & BERNER, LLP, Suite 310, 1700 Diagonal Road, Alexandria, VA, 22314, US

(73) Assignee: YONN YUU ENTERPRISE CO., LTD.

(21) Appl. No.: 10/233,591

(22) Filed: Sep. 4, 2002

(51) Int. Cl. A01D 7/00

(52) U.S. Cl. 56/400.05

(57) ABSTRACT

A socket device with a fastening unit used in a rake or a shovel is described. The socket device has a supporting unit, an assembly unit and a fastening unit by which a handle is attached. The supporting unit has a first opening and a second opening; a first end portion of the handle is inserted into the first opening to affix the handle to the socket device of the garden tool. The assembly unit has a threaded hole and is mounted on the supporting unit to align the threaded hole with the second opening of the supporting unit for assembly of the supporting unit and the handle. The fastening unit coupled to the handle along with the supporting unit has a threaded shaft and engages the threaded shaft and the threaded hole of the assembly unit to secure the handle and the socket device.

### FIELD OF THE INVENTION

The present invention generally relates to a socket device, and more particularly, to a socket device with a fastening unit used in a rake or a shovel to fix interchangeably and readily a handle into the socket device.

### BACKGROUND OF THE INVENTION

Use of garden tools is increasing along with the growing popularity of gardening. Particularly, a gardener uses a rake or a shovel to collect large quantities of weeds or leaves or to dig in the ground. However, a handle of the rake or shovel is immovably fixed in a socket of the rake comb or shovel blade.

FIG. 1 shows a cross-sectional view of a nail socket in a shovel according to the prior art. The shovel has a handle 100, a socket 102, a nail 104 and a blade 106. The handle 100 is located within a hole 108 of the socket 102 and is immovably fixed in the socket 102 by the nail 104. Also, the blade 106 is connected to one end portion of the socket 102 to dig in the ground in the garden.

During the assembly of the shovel, the handle 100 needs to be inserted into the hole 108 of the socket 102. One portion 104a of the nail 104 is then pushed into the handle 100 to attach the handle 100 to the socket 102. Another portion 104b of the nail is naturally exposed and manually deformed by a hammer. As a result, the deformed portion 104b of the nail 104 is distorted to buckle on the surface of the socket 102 and assembles immovably the socket 102 and the handle 100 of the shovel.

Additionally, due to the deformed portion 104b of the nail 104, the nail 104 cannot be detached manually or is damaged severely by a hammer when gardener changes the handle 100 from one type to another. Specifically, a large portion 104a of the nail 104 pushed into the handle 100 for attachment between the handle and the socket results in a great damage to the handle 100. Further, the position of the nail 104 cannot be rapidly and precisely assembled since the nail 104 cannot be guided smoothly by the socket 102 composed of a sheet of plate metal.

### SUMMARY OF THE INVENTION

One object of the present invention is to utilize a socket device to support interchangeably a handle of a rake or a shovel.

Another object of the present invention is to utilize a socket device with a fastening unit to secure rapidly the handle and the socket device to a rake or a shovel.

Still another object of the present invention is to utilize a socket device with a fastening unit to assemble conveniently the handle and the socket of a rake or a shovel.

According to the above objects, the present invention sets forth a socket device with a fastening unit. The socket device has a supporting unit, an assembly unit and a fastening to attach a handle. The supporting unit has a first opening and a second opening; a first end portion of the handle is inserted into the first opening to affix the handle to the socket device on the garden tool.

The assembly unit has a threaded hole and is mounted on the supporting unit to align the threaded hole with the second opening of the supporting unit to assemble the supporting unit and the handle. The fastening unit coupled to the handle along with the supporting unit has a threaded shaft and engages the threaded shaft and the threaded hole of the assembly unit to secure the handle and the socket device.

More importantly, the assembly unit serves as a guiding unit to direct the threaded shaft to guide smoothly the fastening unit. Further, after the attachment between the handle and the socket device is complete, the assembly unit can keep the attachment quite stable all the time. The assembly unit is preferably riveted, soldered or welded onto the socket device by a rivet, a solder or a weld, respectively.

Specifically, one end portion of the threaded shaft of the fastening unit includes a cone portion or a pointed end portion to penetrate the surface region of the handle and to contact tightly the handle and the supporting unit. The hardness of the cone portion is higher than that of the handle for a preferred penetration so as to compress the handle toward the sidewall of the first opening of the supporting unit.

The socket device is preferably suitable for a rake or a shovel. The rake has a handle, a socket device and a plurality of teeth. The teeth are connected to the supporting unit of the socket device and can collect a plurality of articles. Specifically, the teeth are equally spaced and affixed to one end portion opposite to the first opening of the supporting unit. In addition, the socket device preferably includes a plurality of supporting units, assembly units and fastening units to be positioned symmetrically or asymmetrically thereon for a tighter attachment.

The shovel has a handle, a socket device and a blade. The blade connected to the supporting unit of the socket device can dig in the ground. In other words, the blade extends from one end portion of the supporting unit and forms a large area with an edge thereon to dig earth when the handle of the shovel is affixed interchangeably to the socket device.

In summary, the present invention utilizes a socket device with a fastening unit to support interchangeably a handle of a garden tool and to secure rapidly and conveniently the handle and the socket device by an assembly unit mounted on a supporting unit of the socket device for the garden tool. Moreover, the assembly unit of the socket device serves as a guiding unit to direct the threaded shaft to guide smoothly the fastening unit.

### BRIEF DESCRIPTION OF THE DRAWINGS

The foregoing aspects and many of the attendant advantages of this invention will become more readily appreciated as the same becomes better understood by reference to the following detailed description when taken in conjunction with the accompanying drawings, wherein:

FIG. 1 illustrates a cross-sectional view of a nail socket in a shovel according to the prior art;

FIG. 2 illustrates a cross-sectional view of a socket device with a fastening unit in accordance with one preferred embodiment the present invention;

FIG. 3 illustrates a cross-sectional view of a rake using a socket device in accordance with one preferred embodiment the present invention; and

FIG. 4 illustrates cross-sectional view of a shovel with a socket device in accordance with one preferred embodiment the present invention.

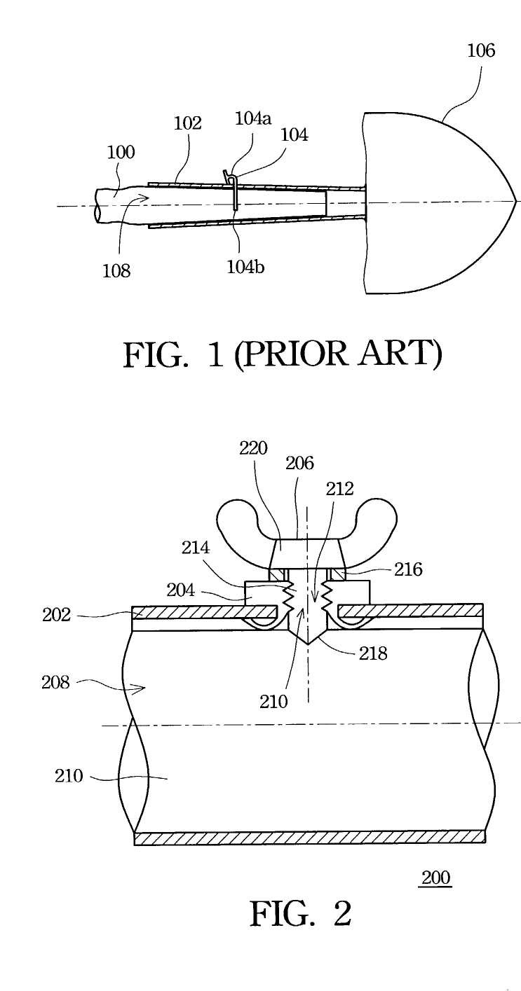

### DETAILED DESCRIPTION OF THE PREFERRED EMBODIMENT

The present invention is directed to a socket device with a fastening unit to support interchangeably a handle of a garden tool. The socket device with a fastening unit is used to secure rapidly and conveniently the handle and the socket device for the garden tool. The garden tool is preferably a rake, a shovel or a spade.

FIG. 2 shows a cross-sectional view of a socket device with a fastening unit in accordance with one preferred embodiment the present invention. The socket device 200 to attach a handle 201 has a supporting unit 202, an assembly unit 204 and a fastening unit 206. The supporting unit 202 has a first opening 208 and a second opening 210; a first end portion of the handle 201 is inserted into the first opening 208 to affix the handle 201 to socket device 200 of the garden tool.

The assembly unit 204 has a threaded hole 212 and is mounted on the supporting unit 202 to align the threaded hole 212 with the second opening 210 of the supporting unit 202 to assemble the supporting unit 202 and the handle 201. The fastening unit 206 attached to the handle 201 along with the supporting unit 202 has a threaded shaft 214 and engages the threaded shaft 214 and the threaded hole 212 of the assembly unit 204 to secure the handle 201 and the socket device 200.

More importantly, the assembly unit 204 serves as a guiding unit to direct the threaded shaft 214 to guide smoothly the fastening unit 206. Further, after the attachment of the handle 201 to the socket device 200 is complete, the assembly unit 204 maintains a stable attachment at all times. The assembly unit 204 is preferably riveted, soldered or welded to the socket device 200 by a rivet, solder or a weld, respectively.

In the preferred embodiment of the present invention, the socket device 200 further includes a resilient ring 216 between the assembly unit 204 and the fastening unit 206 to keep the handle 201 and the socket device 200 in a tight contact. The resilient ring 216 also is positioned between the assembly unit 204 and the supporting unit 202 near the second opening 210. Additionally, the resilient ring 216 allows attachment to the fastening unit 206 for a preferred tight attachment between the assembly unit 204 and the fastening unit 206. Moreover, the resilient ring 216 preferably includes a closed or an open gap flexible ring, such as washer.

Specifically, one end portion 218 of the threaded shaft 214 of the fastening unit 206 includes a cone portion or a pointed end portion to penetrate the surface region of the handle 201 and to contact tightly the handle 201 and the supporting unit 202. The hardness of the cone portion is higher than that of the handle 201 for a preferred penetration so as to compress the handle 201 toward the sidewall of the first opening 208 of the supporting unit 202. Also, one end portion 218 of the threaded shaft 214 is preferably a tilted surface region to compress the handle 201.

The other end portion 220 of the threaded shaft 214 further includes a pair of wings to impose readily a rotating moment to drive the fastening unit 206 into the handle 201. In other words, the fastening unit 206 is horizontally rotated and vertically advances to the handle 201 to attach the socket device 200 and the handle 201.

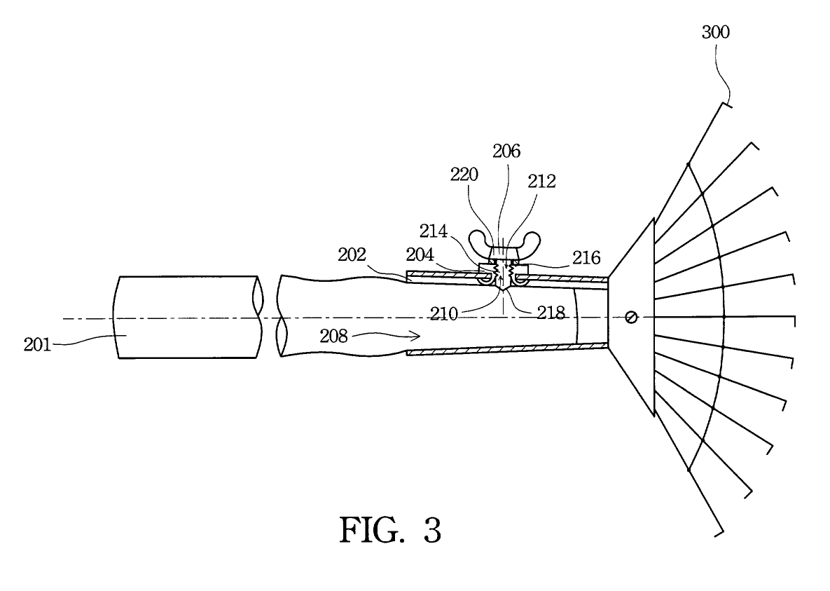

FIG. 3 shows a cross-sectional view of a rake using the socket device in accordance with one preferred embodiment the present invention. The rake has a handle 201, a socket device 200 and a plurality of teeth 300. The handle 201 has a first end portion. The socket device 200 attached to the handle 201 includes a supporting unit 202, an assembly unit 204 and a fastening unit 206.

The supporting unit 202 has a first opening 208 and a second opening 210 therein; the first end portion of the handle 201 is inserted into the first opening 208 to support the handle 201. The assembly unit 204 has a threaded hole 212 therein and is mounted on the supporting unit 202 to assemble the supporting unit 202 and the handle 201. The fastening unit 206 coupled to the handle 201 along with the supporting unit 202 and has a threaded shaft 214 to engage the threaded shaft 214 and the threaded hole 212 of the assembly unit 204 to secure the handle 201 and the socket device 200.

The teeth 300 connected to the supporting unit 202 of the socket device 200 can collect a plurality of articles. Specifically, the teeth 300 are equally spaced and affixed to one end portion opposite the first opening 208 of the supporting unit 202. In addition, the socket device preferably includes a plurality of supporting units 202, assembly units 204 and fastening units 206 to be positioned symmetrically or asymmetrically thereon for a tighter attachment. Consequentially, the handle 201 of the rake is affixed interchangeably to the socket device 202.

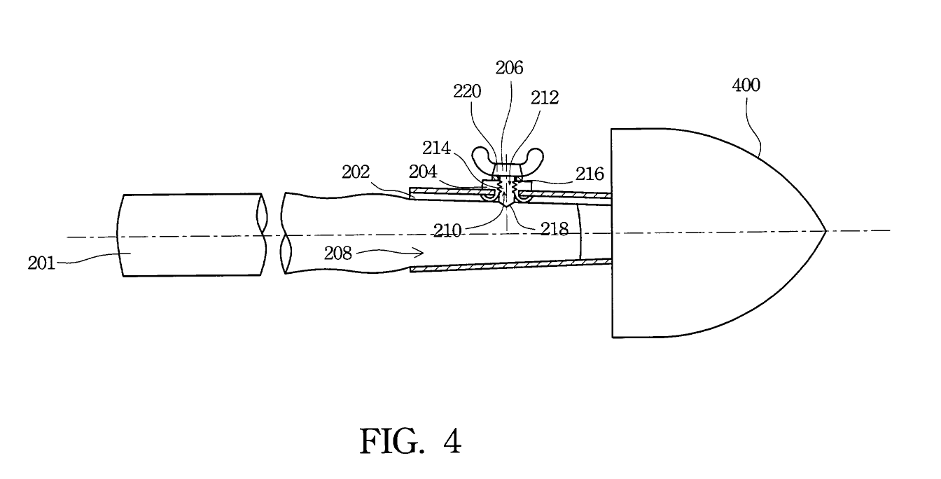

FIG. 4 shows a cross-sectional view of a shovel with the socket device in accordance with one preferred embodiment the present invention. The shovel has a handle 201, a socket device 200 and a blade 400. The handle 201 has a first end portion. The socket device 200 is connected to the handle 201 and has a supporting unit 202, an assembly unit 204 and a fastening unit 206.

The supporting unit 202 has a first opening 208 and a second opening 210; the first end portion of the handle 201 is placed into the first opening 208 to support the handle 201. The assembly unit 204 has a threaded hole 212 therein and is mounted on the supporting unit 202 to assemble the supporting unit 202 and the handle 201. The fastening unit 206 has a threaded shaft 214 and is coupled to the handle 201 along with the supporting unit 202 to engage the threaded shaft 214 and the threaded hole 212 of the assembly unit 204 to secure the handle 201 and the socket device 200.

The blade 400 connected to the supporting unit 202 of the socket device 200 can dig in the ground. In other words, the blade extends from one end portion of the supporting unit 202 and forms a large area with an edge thereon to dig earth when the handle 201 of the shovel is affixed interchangeably to the socket device 202.

According to the above, the present invention utilizes a socket device with a fastening unit to support interchangeably a handle of a garden tool. The socket device with a fastening unit allows the handle to be secured rapidly and conveniently and the socket device is mounted on a supporting unit for the garden tool. Moreover, the assembly unit of the socket device serves as a guiding unit to direct the threaded shaft for guiding smoothly the fastening unit.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A rake, comprising:
a handle having a first end portion;
a socket device connected to the handle and including:
a supporting unit having a first opening and a second opening therein, wherein the first end portion of the handle is inserted into the first opening for supporting the handle;
an assembly unit having a threaded hole therein and mounted on the supporting unit to align the threaded hole with the second opening of the supporting unit for assembling the supporting unit and the handle; and
a fastening unit having a threaded shaft and coupled to the handle along with the supporting unit to engage the threaded shaft and the threaded hole of the assembly unit for securing the handle and the socket device; and
a plurality of teeth connected to the supporting unit of the socket device for collecting a plurality of articles.

2. The rake of claim 1, wherein the socket device further comprises a resilient ring between the assembly unit and the fastening unit to keep the handle and the socket device in tight contact.

3. The rake of claim 1, wherein a first end portion of the threaded shaft of the fastening unit comprises a cone portion to penetrate a surface region of the handle for creating a tight contact between the handle and the supporting unit.

4. The rake of claim 3, wherein a hardness of the cone portion is higher than that of the handle for a preferred penetration.

5. The rake of claim 3, wherein a second end portion of the threaded shaft further comprises a pair of wings to impose readily a force for driving the fastening unit into the handle.

6. A shovel, comprising:
a handle having a first end portion;
a socket device connected to the handle and including:
a supporting unit having a first opening and a second opening therein, wherein the first end portion of the handle is inserted into the first opening for supporting the handle;
an assembly unit having a threaded hole therein and mounted on the supporting unit to align the threaded hole with the second opening of the supporting unit for assembling the supporting unit and the handle; and
a fastening unit having a threaded shaft and coupled to the handle along with the socket unit to engage the threaded shaft and the threaded hole of the assembly unit for securing the handle and the socket device; and
a blade connected to the supporting unit of the socket device for removing articles.

7. The rake of claim 6, wherein the socket device further comprises a resilient ring between the assembly unit and the fastening unit to keep the handle and the socket device in tight contact.

8. The rake of claim 6, wherein a first end portion of the threaded shaft of the fastening unit comprises a cone portion to penetrate a surface region of the handle and create a tight contact between the handle and the supporting unit.

9. The rake of claim 8, wherein a hardness of the cone portion is higher than that of the handle for a preferred penetration.

10. The rake of claim 8, wherein a second end portion of the threaded shaft further comprises a pair of wings to impose readily a force for driving the fastening unit into the handle.

11. A socket device for attaching a handle to a rake, the socket device comprising:
a supporting unit having a first opening and a second opening therein, wherein a first end portion of the handle is inserted into the first opening for supporting the handle;
an assembly unit having a threaded hole therein and mounted on the supporting unit to align the threaded hole with the second opening of the supporting unit for assembling the supporting unit and the handle; and
a fastening unit having a threaded shaft and coupled to the handle along with the supporting unit to engage the threaded shaft and the threaded hole of the assembly unit for securing the handle and the socket device.

12. The rake of claim 11, wherein the socket device further comprises a resilient ring between the assembly unit and the fastening unit to keep the handle and the socket device in tight contact.

13. The rake of claim 11, wherein a first end portion of the threaded shaft of the fastening unit comprises a cone portion to penetrate a surface region of the handle and create a tight contact between the handle and the supporting unit.

14. The rake of claim 13, wherein a hardness of the cone portion is higher than that of the handle for a preferred penetration.

15. The rake of claim 13, wherein a second end portion of the threaded shaft further comprises a pair of wings to impose readily a force for driving the fastening unit into the handle.
